(19) United States
(12) Patent Application Publication
(10) Pub. No.: US 2012/0267217 A1
(43) Pub. Date: Oct. 25, 2012

(54) Device For Feeding Book Blocks To A Book Binding Machine

(76) Inventors: Martin Nolte, Rahden (DE); Dirk Rygol, Rheine (DE)

(21) Appl. No.: 13/452,024

(22) Filed: Apr. 20, 2012

(30) Foreign Application Priority Data
Apr. 23, 2011 (DE) 10 2011 018 510.0

(51) Int. Cl. B65G 37/00

(52) U.S. Cl. 198/610

(57) ABSTRACT

In a feed device (1) for a perfect binder, it is proposed that a vibrator device (5) features at least one first vibrating plate (6.1) that is inclined relative to the horizontal line and on which the sheet stacks (2) are aligned while they stand on first sheet edges (2 a) and second sheet edges (2 b) contact an aligning element (6.2) that is stationarily arranged in a plane lying perpendicular to the first vibrating plate (6.1), and that a conveying device (30) is realized in the form of a clamping conveyor (30, 31.1 . . . 4) for receiving aligned sheet stacks (2) from an inclined, stationary position (21) in the vibrator device (5) and for synchronously, positively transferring (22) said sheet stacks to the continuously driven book block conveying device with the block spine (2 a) positioned horizontally.

### BACKGROUND

The invention pertains to a device for feeding book blocks to a book binding machine.

In book binding machines that are known as perfect binders, perfect-bound brochures or book blocks for hard covers are produced, wherein the glue is applied on the previously processed spine of the book blocks and a cover and/or a lining strip is placed around and pressed against the block spine. Various binding processes and product variations can be realized depending on the equipment of the perfect binder.

DE 20 2005 007 012 U1 describes such a book binding machine with a book block conveying device consisting of an endless conveying means that continuously revolves around guide rollers and a plurality of clamps for clamping book blocks that are arranged on the conveying means in such a way that they are equidistantly spaced apart from one another. Various processing stations are arranged along straight conveying sections of the oval. There also exist linearly operating perfect binders with a clamping plate conveyor consisting of two revolving plate chains, between which the book blocks are clamped at fixed distances from one another and transported.

The loose book blocks reach the perfect binder via a transfer channel, wherein the book blocks are continuously pushed forward in a channel with a bottom and lateral guide walls by transport bars and pass one or more vibrator stations during this process. In this case, the book blocks are guided over vibrating plates while they stand on their spine and are transported in the longitudinal direction of the spine in order to be aligned in the spine and at the head such that the all folded sections and/or individual sheets lie in one plane.

However, such a transfer of the book blocks is associated with certain problems, particularly in the processing of book blocks that are exclusively composed of individual sheets and/or quarter sections and typically produced in digital printing systems. The outer sheets have a tendency to travel upward on the guide walls or to creep underneath the block spine or to place themselves between the transporter and the head of the book block while it is pushed forward. Individual sheets that already protrude during the infeed of the book block cannot be sufficiently forced back into the sheet stack and aligned while the book block is pushed forward over the vibrator section such that prior straightening of the book blocks is required in connection with a careful and therefore laborious insertion of the sheet stack into the transfer channel. Furthermore, individual sheets or block sections may shoot forward when the machine is stopped.

In other known systems, a robot equipped with a gripper picks up book blocks that were aligned on a stationary vibrating table and places the book blocks into a stationary clamp [Professional Article “Über 4.000 Produkte am Tag: Klebebindung inn Akkord mit Roberto;” Deutscher Drucker, No. 26, Aug. 19, 2000, Page 25]. The complicated transfer system is only suitable for perfect binders of the lower capacity range, in which the clamps are driven intermittently. In addition, the robot merely picks up the book blocks in a laterally clamped fashion such that block sections may shift and the previously realized alignment may be lost.

### SUMMARY

The present invention is based on the objective of developing a device for feeding book blocks to a book binding machine, which device has a simple construction and also allows the flawless alignment and transfer of sheet stacks or book blocks that are composed, in particular, of individual sheets at higher production speeds. As used herein, “sheet stacks” includes folded sections, quarter sections and/or individual sheets.

This objective is attained in that the vibrator device features at least one first vibrating plate that is inclined relative to the horizontal line and on which the sheet stacks are aligned while they stand on first sheet edges and second sheet edges contact an aligning element that is stationarily arranged in a plane lying perpendicular to the first vibrating plate, and in that the conveying device is realized in the form of a clamping conveyor for receiving aligned sheet stacks from an inclined, stationary position in the vibrator device and for synchronously, positively transferring said sheet stacks to the continuously driven book block conveying device with the block spine positioned horizontally.

The sheet stacks are no longer pushed into the perfect binder through a channel, but rather transported in a clamped fashion by a clamping conveyor. The prior alignment of the sheet stacks realized in the upstream vibrator device is preserved. The clamping conveyor only releases the sheet stack once the plate chains of a clamping plate conveyor or the clamps of a revolving clamp-type transport system are closed such that a positive transfer is ensured and potential shifting of the block is precluded. The vibrating plate inclined relative to the horizontal line ensures an effective alignment of the sheet stacks in the spine and at the head of the book blocks such that even sheet stacks in extreme disarray can be flawlessly processed. The laborious manual straightening of the sheet stacks prior to the infeed can be eliminated or at least becomes less intensive. The sheet stacks are no longer transported by being pushed in a direction parallel to the sheet plane while they are subjected to the vibrations, but rather contact the stationary aligning element with their head or foot such that the outer sheets no longer travel upward and/or creep. The sheet stacks are received by the clamping conveyor in the inclined orientation, in which they were aligned and a stable position of the sheet stacks is ensured, and not turned into the horizontal block spine opposition until they have been received by the clamping conveyor.

An adequate alignment can be achieved if the first vibrating plate has an angle of inclination of about 30 to 60°, preferably 45°. In this case, the sheet stacks are aligned in the direction of the block spine, as well as in the direction of the head. Different format heights of the book blocks can be taken into consideration if the aligning element is adjustable relative to the first vibrating plate in the direction of the first sheet edges of the sheet stack. An even more intensive and therefore faster alignment can be achieved if the aligning element is realized in the form of a second vibrating plate.

According to a preferred additional development, the vibrator device features lateral guide plates that are arranged perpendicular to the first vibrating plate and parallel to one another. The guidance on both sides makes it possible to securely position and flawlessly align the sheet stacks on the vibrating plates. The mutual distance between the guide plates preferably can be adjusted in accordance with the block thickness such that the sheet stacks are always tightly guided. It is advantageous if the guide plates can be adjusted into predefined positions for guiding, clamping and releasing the sheet stacks with the aid of actuating means. This ensures that the sheet stacks are tightly guided when they are vibrated and aligned. The sheet stacks may be clamped by the guide plates if they should be subsequently received by the clamping conveyor. This ensures that the aligned sheet stacks are flawlessly received by the clamping conveyor. The release position ultimately allows the flawless further transport of the sheet stack by the clamping conveyor.

The guide plates can be used for displacing the sheet stacks on the vibrating plates by realizing the guide plates such that they are respectively displaceable in the direction of their normal or parallel to the first vibrating plate. The sheet stacks are transversely displaced, for example, in order to displace the sheet stacks from a manual feed into a designated position for the transfer to the clamping conveyor. Creeping or traveling of the outer sheets also does not occur in this case because the sheet stacks are not displaced in a direction parallel to the sheet plane. The vibrator device preferably features a settling area that consists of rigid plates connected to the at least one first vibrating plate with interengaging tabs and/or obliquely extending joints, wherein the aligned sheet stacks are transferred to the clamping conveyor from this settling area. The sheet stacks are displaced from the vibrating area into the settling area and can be flawlessly received by the clamping conveyor in the form of stationary sheet stacks.

According to a preferred additional development, a plurality of guide plates are provided and coupled to a revolving conveying means in order to form a revolving pocket conveyor system, in which receptacle pockets for the sheet stacks are respectively formed between successive guide plates. Several sheet stacks can be simultaneously stockpiled and aligned. This results in several infeed points for the manual infeed of sheet stacks. The revolving pocket conveyor system makes it possible to convey sheet stacks in the vibrator device from the manual feed to the vibrating area that may have zones of different vibration intensity and ultimately to the designated position in the settling area.

If the revolving pocket conveyor system extends up to the delivery area of the book binding machine, it can be simultaneously used for receiving and storing processed or bound book blocks from the book block conveying device. The bound books may remain in the pocket conveyor system in order to dry and, if applicable, be transported as far as the manual feed of the sheet stacks such that one worker can handle the feeding of sheet stacks, as well as the removal of bound books.

Variable distances between the guide plates can be realized if the guide plates can be engaged and disengaged on/from the revolving conveying means by means of driving cams. Aligned sheet stacks can be easily received by the clamping conveyor due to the fact that the guide plates are arranged at a distance from the first vibrating plate and also have such a thickness that clamping elements of the clamping conveyor can move in the thusly created space between the guide plate and the vibrating plate.

According to a preferred additional development, at least one intermittently driven clamping carriage is provided as clamping conveyor and receives the aligned sheet stacks from the vibrator device by means of clamping strips that laterally take hold of the block spine and supporting plates that support the block spine. A flawless transport by means of the clamping carriage is ensured due to the fact that the sheet stacks are not only laterally clamped, but also supported by supporting plates of the clamping carriage. The clamping force to be generated can be limited to a minimum in order to protect the product. The height of the clamping strips that laterally engage on the block spine can be maintained so small that the sheet stacks can be transported in a gripped fashion as far as the clamps or the clamping plate conveyor of the book block conveying device without being prematurely released and remain in the clamps or the clamping plate conveyor until it is closed such that a positive transfer is ensured and potential shifting of the block is precluded.

In an inclined arrangement of the vibrator device, in which the sheet stacks are inclined relative to the vertical line, the sheet stacks contact one side of the pocket such that a second guide plate to be adjusted in dependence on the thickness can be eliminated. It also suffices to guide the book block that upwardly protrudes from the clamping conveyor one only side during the further transfer into the perfect binder.

### BRIEF DESCRIPTION OF THE DRAWING

Aspects of the invention are described below with reference to one exemplary embodiment shown in the drawing, wherein

FIG. 1 shows a perspective view of a feed device for a perfect binder with a vibrator device that is realized in the form of a revolving pocket conveyor system and a revolving clamping carriage conveyor;

FIG. 2 shows a front view of the feed device according to

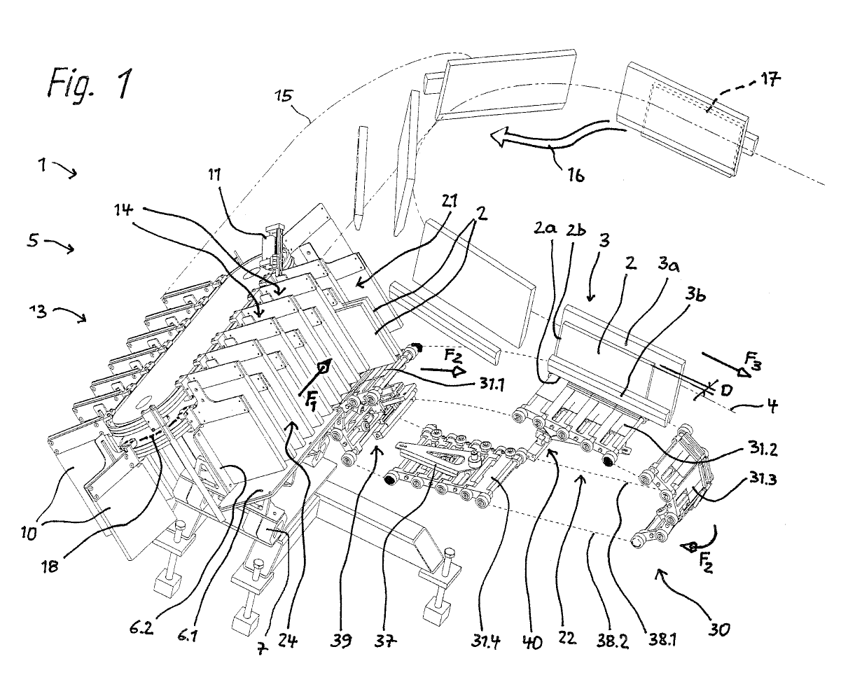

FIG. 1;

FIG. 3 shows a top view of the vibrating plates of the vibrator device;

FIG. 4 shows a side view of the vibrator device;

FIG. 5 shows a second perspective view of the pocket conveyor system;

FIG. 6 shows a detail of the pocket conveyor system, and

FIGS. 7a,b show perspective top and bottom views of a clamping carriage.

### DETAILED DESCRIPTION

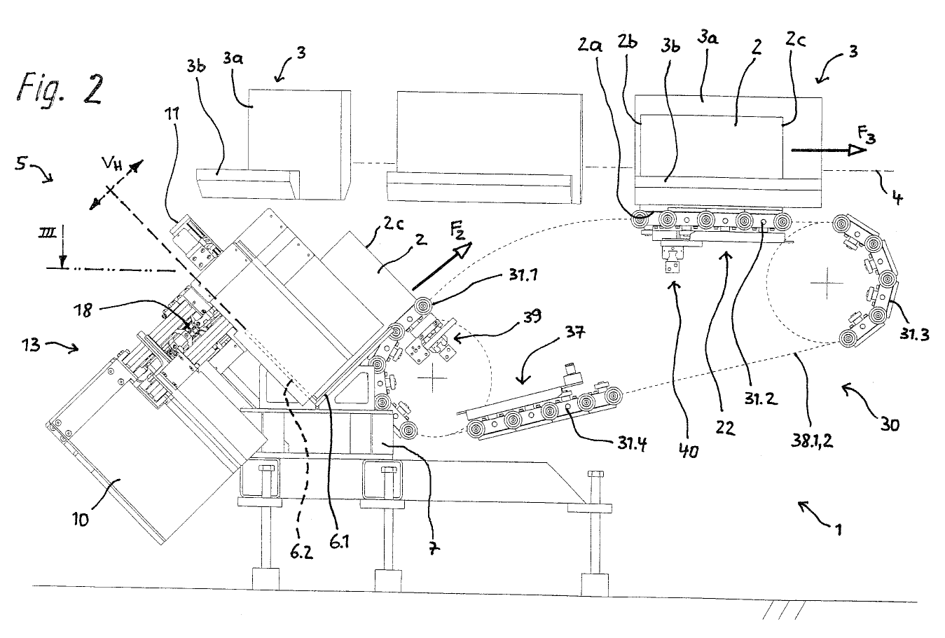

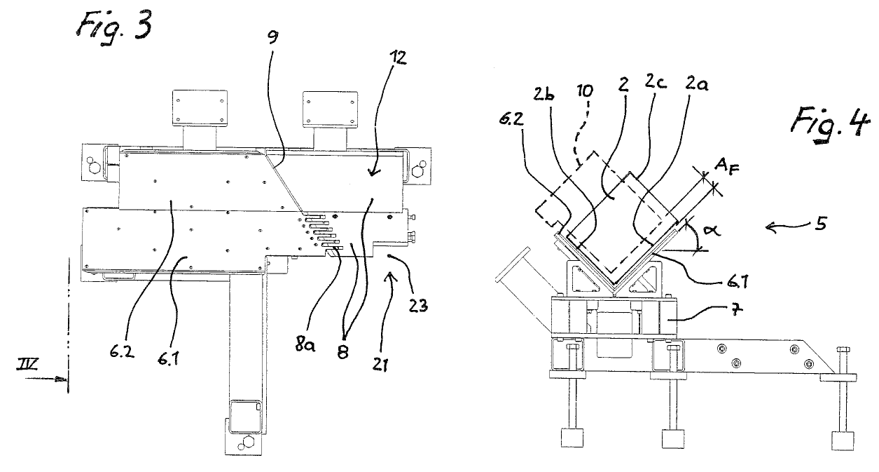

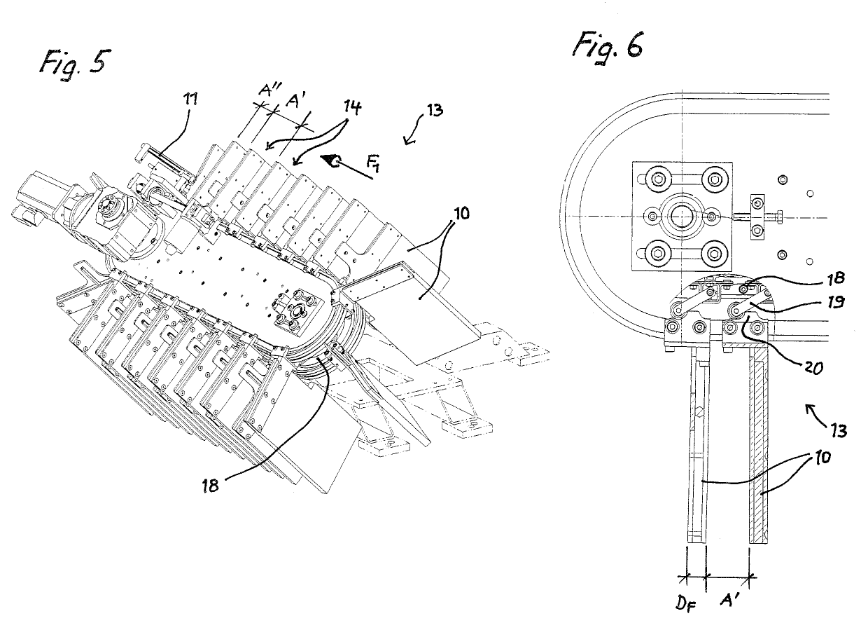

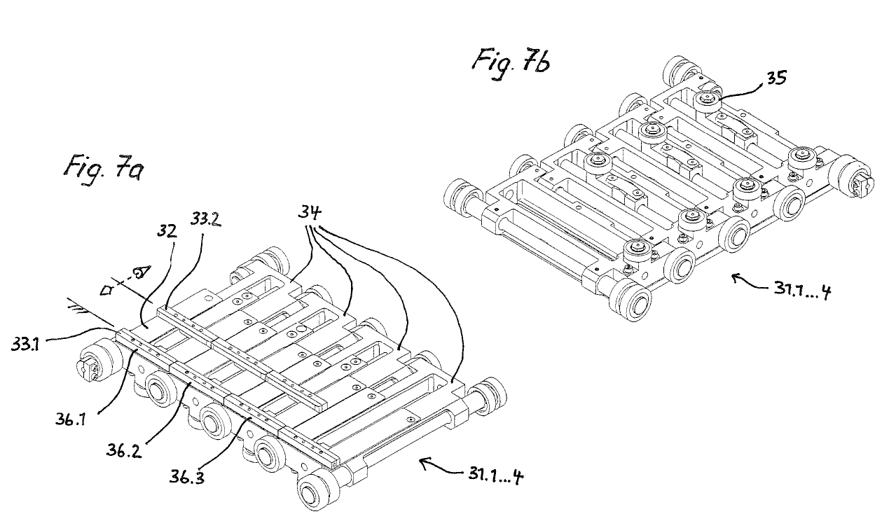

FIGS. 1 and 2 show part of a perfect binder that consists of a book block transport system with a plurality of block clamps 3 that can be continuously moved along a closed oval track in a conveying direction F3 and are equidistantly coupled to and driven by a conveyor chain 4, with a feed device 1 for feeding sheet stacks that are predominantly composed of individual sheets and/or quarter sections or so-called loose book blocks 2, and with a delivery area 16 that is symbolically illustrated in the form of an arrow and serves for delivering brochures 17 or book blocks that were perfect-bound in the perfect binder. Various stations that are not illustrated in detail in FIGS. 1 and 2 and serve for processing and gluing the spine, as well as for applying and pressing on covers, are arranged along straight conveying sections of the oval track.

The block clamps 3 may consist of block clamps that close in a parallel fashion and feature an inner stationary clamping jaw 3 a and an outer clamping jaw 3 b that can be displaced perpendicular to the inner clamping jaw 3 a or of block clamps that can be pivoted open in a translatory fashion and in which the outer clamping jaw 3 b can be moved relative to the inner stationary clamping jaw 3 a by means of a pivot arm. In the region of the deflection illustrated in FIG. 1, opened block clamps 3 travel from the delivery area to a transfer area 22, in which the book blocks 2 supplied by the feed device 1 are received by closing the block clamps 3 and further transported, wherein the edge of block spine 2 a downwardly protrudes from the block clamps 3 by a defined distance. The head 2 b of the book blocks 2 lies at the rear referred to the conveying direction F3.

The perfect binder may also consist of a linearly operating perfect binder with a clamping plate conveyor consisting of two revolving plate chains, between which the book blocks are clamped within fixed distances from one another and transported.

According to the present disclosure, the feed device 1 includes a separate vibrator device 5 for aligning sheet stacks or unbound book blocks 2 supplied by a manual feed or a coupling to upstream machines such as a gathering machine or a digital printing machine, as well as a clamping carriage conveyor 30 for transferring the book blocks 2 aligned in the vibrator device 5 into the block clamps 3.

The vibrator device 5 features first and second vibrating plates 6.1, 6.2 that are mounted on oscillatory elements 7, wherein these vibrating plates are arranged perpendicular to one another and inclined relative to the horizontal line by an angle α of preferably 45°. The loose book blocks 2 stand on the first vibrating plate 6.1 with first sheet edges in the form of their block spine 2a and contact the aligning element in the form of a second vibrating plate 6.2 with different, second sheet edges, in this case the head 2 b of the book block 2. The lateral guidance is realized with guide plates 10.

The vibrator device 5 is realized in the form of a revolving pocket conveyor system 13. A plurality of guide plates 10 are coupled to a revolving conveyor chain 18, wherein a receptacle pocket 14 is respectively formed between successive guide plates 10. The pocket conveyor system 13 has a conveying direction F1. Book blocks 2 supplied in the area of a manual feed 24 are successively transported into a designated position 21 and transversely displaced over the vibrating plates 6.1, 6.2 during this process.

According to FIG. 3, the vibrating plates 6.1, 6.2 do not extend over the entire length of the vibrator device 5. They end in front of the designated position 21. Rigid plates 8 are connected to the vibrating plates 6.1, 6.2 with interengaging tabs 8 a and obliquely extending joints 9 and form a settling area 12, in which the aligned book blocks 2 become stationary in order to be flawlessly received by the clamping carriage conveyor 30. The vibrating plates 6.1, 6.2 may also extend into the settling area 12, wherein only slight vibration intensity would exist in the settling area 12 and reduce the friction during the transverse transport into the designated position 21, as well as allow the transfer of the aligned book blocks 2 from a quasi-stationary position.

The guide plates 10 are engaged on driving cams 20 of the conveyor chain 18 by means of spring-connected roller levers 19 such that a certain distance N is defined between the guide plates. The guide plates 10 can be disengaged from the conveyor chain 18 and held in certain positions by actuating means such that a distance A″ that is adapted to the block thickness D can be adjusted between the guide plates 10.

FIGS. 1, 2 and 5 show an actuating element 11 that is arranged above the pocket conveyor system 13 and makes it possible to respectively hold a front guide plate 10 in the designated position 21 while the trailing rear guide plate 10 is additionally moved by the conveyor chain 18, the drive of which is controlled in dependence on the block thickness D and the cycle of the perfect binder, until the book block 2 is laterally clamped in this receptacle pocket 14.

Additional actuating elements are respectively provided underneath and within the pocket conveyor system 13. In the designated position 21, from which an aligned book block 2 is transported away by means of the clamping carriage conveyor 30, the guide plates 10 therefore can initially be held in a tight guide position, the dimensions of which are adjusted in accordance with the block thickness D, then displaced into a clamping position, in which the aligned (individual) sheets of the book block 2 are clamped between the two guide plates 10, and ultimately displaced into a release position after the book block 2 has been received by the clamping carriage conveyor 30.

After a book block 2 has been received by the clamping carriage conveyor 30, the front guide plate 10 once again engages into the conveyor chain 18 in order to return into the area of the manual feed 24, in which new book blocks 2 can be placed into the receptacle pockets 14. The guide plates 10 may also be alternately coupled to two separately driven conveyor chains. In this case, the receptacle pockets 14 lie between the first and the second guide plate 10, between the third and the fourth guide plate, etc., wherein the first guide plate 10, the third guide plate, etc. are coupled to the first conveyor chain and the second guide plate, the fourth guide plate, etc. are coupled to the second conveyor chain. A distance A′ that is adapted to the block thickness D can then be adjusted in the receptacle pockets 14 by shifting the phase of the second conveyor chain relative to the first conveyor chain.

The second vibrating plate 6.2 can be adjusted in accordance with the adjustment arrow VH together with the pocket conveyor system 13. This ensures that the foot 2 c of the book block 2 still lies in the region of the outer edge of the vibrating plate 6.1 when the format height of the book blocks is changed such that the book blocks 2 can be received by the clamping carriage conveyor 30.

The clamping carriage conveyor 30 features a total of four clamping carriages 31.1 . . . 4 that successively revolve around the closed track in a conveying direction F2. According to FIGS. 7a and b, each clamping carriage 31.1 . . . 4 has clamping carriage elements 34 that are connected to one another in an articulated fashion and flexible in a first direction, but transversely stable in a second direction. Supporting plates 32 are provided in the clamping carriages 31.1 . . . 4 and support the block spine 2 a of the book blocks 2 to be transferred while they are laterally clamped at the block spine by clamping strips 33.1, 33.2. The individual clamping sections 36.1 . . . 3 formed in accordance with the clamping carriage elements 34 can be opened and closed by actuating control rollers 35 arranged on the underside. Since the perfect binder features stationary inner clamping jaws 3 a, first clamping strips 33.1 are also arranged stationarily and second clamping strips 33.2 are arranged displaceably on the clamping carriages 31.1 . . . 2. It would also be possible to arrange both clamping strips 33.1 and 33.2 displaceably.

A pre-adjusting device 37 makes it possible to adjust the opening width of the clamping strips 33.1, 33.2 in accordance with the block thickness D of the book block 2 to be received. In this case, the clamping carriages 31.1 . . . 4 move into the designated position 21 of the vibrator device 5 from underneath through an opening 23. During this process, the clamping strips 33.1, 33.2 are able to move in the respective space between the book blocks 2 that is defined by a certain thickness DF of the guide plates 10 and their distance AF from the vibrating plate 6.1. The individual clamping sections 36.1 . . . 3 are then successively closed by means of a closing device 39.

The clamping carriages 34.1 . . . 4 are driven intermittently and have a standstill phase, in which the first clamping section 36.1 is closed. The respective clamping carriage 31.1 . . . 4 with the book block 2 clamped in the first clamping section 36.1 is then advanced with a relatively slow speed, wherein a respectively following clamping section 36.2 . . . 3 is closed during the conveying motion of the clamping carriage 34.1 . . . 4 as soon as it approaches the block spine 2 a. After all clamping sections 36.1 . . . 3 have been closed, the clamping carriage 31.1 . . . 4 can be moved to the block clamps 3 with a significantly accelerated speed, wherein the book block 2 is inserted into the open block clamp 3 from underneath. During a synchronized phase with the block clamp 3 moving with a constant speed in the transfer area 22, the block clamp 3 is initially closed and all clamping strips 33.1, 33.2 are subsequently opened over all clamping sections 36.1 . . . 3 by means of the opening device 40. This means that the book blocks 2 are no longer released after they were received from the vibrator device 5 until they are firmly clamped in the block clamps 3 such that a so-called positive transfer is achieved.

In order to respectively drive the four successively revolving clamping carriages 31.1 . . . 4 in the above-described fashion and to furthermore allow a position-dependent placement of the book block 2 in the block clamp 3, successive clamping carriages 31.1 and 31.2 or 31.2 and 31.3, etc., are respectively coupled to conveyor chains 38.1, 38.2 that are driven independently of one another. The clamping carriages 31.1 and 31.3 are coupled to the conveyor chain 38.1 and the clamping carriages 31.2 and 31.4 are coupled to the conveyor chain 38.2.

In FIG. 1, the broken lines 15 indicate an additional development of the invention, in which the pocket conveyor system 13 is extended as far as the delivery area 16 of the perfect binder. Brochures 17 or book blocks that were perfect-bound in the perfect binder can be placed into the receptacle pockets 14 and remain therein in order to dry, wherein the brochures or book blocks may, if applicable, be transported as far as the manual feed 24 of the book blocks such that one worker can handle the feeding of the book blocks 2, as well as the removal of bound brochures 17.

1. A device for feeding book blocks (2) in the form of sheet stacks (2) to a book binding machine, comprising
a continuously driven book block conveying device (4) with clamping elements (3) that laterally clamp the sheet stacks (2), with a stack spine edge (2a) downwardly protruding from the clamping elements (3),
a vibrator device (5) for aligning the sheet stacks (2), and
a transfer conveying device (30) for the synchronous transfer of the sheet stacks (2) to the book block conveying device,
wherein the vibrator device (5) includes at least one first vibrating plate (6.1) that is inclined relative to horizontal and on which the sheet stacks (2) are aligned while they stand on their spine edges (2a) and an aligning element (6.2) that is stationarily arranged in a plane lying perpendicular to the first vibrating plate (6.1) and which contacts other sheet edges (2b), and
wherein the transfer conveying device (30) is a clamping conveyor (30, 31.1 . . . 4) for receiving aligned sheet stacks (2) from an inclined, stationary position (21) in the vibrator device (5) and for synchronously, positively transferring (22) said aligned sheet stacks to the continuously driven book block conveying device with said spine edge (2a) positioned horizontally.

2. The device according to claim 1, wherein the first vibrating plate (6.1) has an angle of inclination (a) of between about 30 to 60°.

3. The device according to claim 1, wherein the aligning element (6.2) is adjustable relative to the first vibrating plate (6.1) in a direction along the spine edges (2a) of the sheet stack (2).

4. The device according to claim 1, wherein the aligning element is a second vibrating plate (6.2).

5. The device according to claim 1, wherein the vibrator device (5) includes lateral guide plates (10) that are arranged perpendicular to the first vibrating plate (6.1) and parallel to one another.

6. The device according to claim 5, wherein a mutual distance (A′, A′) between the guide plates (10) is adjustable to accommodate different thicknesses (D) of the sheet stacks (2).

7. The device according to claim 5, including an actuator (11) operatively associated with the guide plates (10) for adjusting the guide plates (10) into predefined positions for guiding, clamping and releasing the sheet stacks (2) to the transfer conveying device (30).

8. The device according to claim 5, wherein the guide plates (10) are displaceable in the direction parallel to the first vibrating plate (6.1).

9. The device according to claim 8, wherein the vibrator device (5) includes a settling area (12) comprising rigid plates (8) connected to the at least one first vibrating plate (6.1) with at least one of interengaging tabs (8 a) or obliquely extending joints (9), whereby the aligned sheet stacks (2) are transferred to the clamping conveyor (30, 31.1 . . . 4) from this settling area.

10. The device according to claim 8 wherein a plurality of guide plates (10) are coupled to a revolving conveyor (18) in order to form a revolving pocket conveyor system (13), in which receptacle pockets (14) for the sheet stacks (2) are respectively formed between successive guide plates (10).

11. The device according to claim 10, wherein the revolving pocket conveyor system (13) extends as far as a delivery area (16) of the bookbinding machine in order to receive and store processed or bound book blocks (17) from the book block conveying device.

12. The device according to claim 10 wherein the guide plates (10) can be engaged and disengaged on/from the revolving conveyor (18) by driving cams (20).

13. The device according to claim 10, wherein the guide plates (10) are arranged at a distance (A_{F}) from the first vibrating plate (6.1) and also have such a thickness (D_{F}) that clamping elements (33.1, 33.2) of the transfer conveyor (30, 31.1 . . . 4) can move in a thusly created space between the guide plate (10) and the vibrating plate (6.1).

14. The device according to claim 1, wherein the vibrator device (5) is arranged at an incline such that the sheet stacks (2) are inclined relative to vertical.

15. The device according to claim 1, wherein the clamping conveyor of the transfer conveying device (30) is in the form of at least one intermittently driven clamping carriage (31.1 . . . 4) with clamping strips (33.1, 33.2) that laterally take hold of the aligned sheet stack (2) on the block spine and supporting plates (32) that support the block spine (2a).
